(19) United States
(12) Patent Application Publication
(10) Pub. No.: US 2024/0264028 A1
(43) Pub. Date: Aug. 8, 2024

(54) DEVICE FOR MONITORING A ROOM

(71) Applicant: CONSOMIX, PARIS (FR)

(72) Inventors: Meyer Patrick MELUL, PARIS (FR); Dann MELUL, TEL-AVIV (IL)

(21) Appl. No.: 18/567,979

(22) PCT Filed: Jun. 7, 2022
(86) PCT No.: PCT/EP2022/065400

§ 371 Date: Dec. 7, 2023

(30) Foreign Application Priority Data
Jun. 7, 2021 (FR) FR2105995

(51) Int. Cl. G01M 3/04; G01M 3/16; G01M 3/24; G01M 3/26; G01M 3/38

(52) U.S. Cl. CPC G01M 3/04; G01M 3/16; G01M 3/24; G01M 3/26; G01M 3/38

(57) ABSTRACT

A monitoring device for monitoring a room, the monitoring device including at least one first sensor for detecting a physical parameter, a calculator configured to deduce the presence of a volume of water in the room from the physical parameter, the calculator being configured to generate a first signal when the volume of water exceeds a predefined threshold, the first signal being emitted to a remote equipment by a communication interface of the monitoring device.

### FIELD

The field of the invention relates to the field of monitoring devices. In particular, the field of the invention relates to the field of devices for monitoring the status of a room such as a service room. More particularly, the field of the invention relates to the field of devices for monitoring the presence of water in a room to identify, anticipate or even prevent the occurrence of a leak or flooding.

### PRIOR ART

Service rooms are particularly sensitive places and often not very accessible, in which material damage caused by flooding can be considerable before it is discovered. Apart from the often very high financial consequences, the consequences of flooding in a service room such as a boiler room or an elevator can have a significant impact on the lives of the inhabitants of a damaged building. For example, the potential damage caused by flooding in a boiler room can be numerous: damage caused to the building, pipes, equipment such as exchangers, pumps or even the boiler. Although their economic impact is difficult to quantify, in France the damage caused by flooding of boiler rooms is estimated at more than one billion euros.

Furthermore, these risks are reflected in the value of the properties. They directly impact insurance premiums and the payment of deductibles. Apart from the technical impacts, flooding often causes service interruptions that can be misunderstood by occupants, who are deprived of a lift or collective heating in winter. The socio-economic challenges associated with the damage caused by flooding in service rooms are therefore extremely important.

Flooding in service rooms may be caused by three main factors:
Leaks in a pressurized system such as a heating system, or leaks in a damaged pipe. Due to the operating pressure of such circuits, even the smallest leak quickly becomes considerably important.
Malfunctions of drainage systems, such as one or more lift pumps, which may prevent the evacuation of discharged water.
Natural disasters, such as sudden floods or marine submersions, which have been on the rise since the last decade of the twentieth century.

Currently, existing solutions for detecting leaks or flooding within rooms have a number of limitations. For example, there are solutions that rely on the detection of a physical parameter using a type of sensor. However, such solutions lack flexibility, notably from the point of view of the installation, which may not necessarily be suitable for all types of rooms. In addition, the use of a single type of sensor greatly limits the chances of achieving optimal detection and the risks of missing the presence of a leak or flood are significant.

Another problem with existing solutions is the need for frequent maintenance. Indeed, to ensure the effectiveness of a monitoring device, it is also necessary to ensure the proper operation of the equipment of the device over time. However, existing solutions require frequent maintenance, because a defect in a single item of equipment may suffice to make a device fail. Such follow up can prove to be complex over time and incur significant costs.

Another problem with existing solutions is the lack of granularity. Indeed, there are solutions that rely solely on the data acquired by their own sensors. However, it may be necessary to cross-check this data with data acquired by third party equipment, for example weather data in the case of flood detection, in order to obtain optimal identification of the cause of the presence of water in a room.

Finally, another problem with prior art solutions is the absence of a global view. Indeed, in existing solutions, the rooms are monitored independently of each other. Such solutions are not suitable for the management of an assembly of a plurality of rooms that are for example distributed over a territory.

There is therefore a need to facilitate, make reliable and optimize the detection of leaks and flooding within rooms, notably such as service rooms.

### SUMMARY OF THE INVENTION

The invention detailed below makes it possible to overcome the aforementioned drawbacks.

According to a first aspect, the invention relates to a monitoring device for monitoring a room, said monitoring device comprising:
at least one first sensor for detecting a physical parameter,
a calculator configured to deduce the presence of a volume of water in said room from said physical parameter, said calculator being configured to generate a first signal when the volume of water exceeds a predefined threshold, said first signal being emitted to a remote equipment by means of a communication interface of said monitoring device.

In one embodiment, the monitoring device comprises a main container and a secondary container arranged in the room, said secondary container comprising means for allowing the passage of a volume of water discharged into the main container to said secondary container when pressure is applied by said discharged volume of water on said means, at least one of said containers comprising a detection sensor for measuring a physical parameter of the discharged volume of water, said detection sensor being configured to transmit in real time to the calculator at least one item of information about a height of a fluid contained by one of the containers, said information being processed by said calculator to generate a command to activate at least one hydraulic equipment to vary, in one of said containers, the height of the discharged volume of water.

One advantage is to be able to carry out functional tests of one or more items of equipment as a function of a volume of water discharged into one or more containers.

Another advantage is to automatically generate a command to lower the water level in a container when this level exceeds a predefined threshold.

In one embodiment, the monitoring device comprises a water meter for measuring a physical parameter relating to a fluid passing through equipment of a hydraulic system installed for at least a part in said room or in its proximity, counting information being sent to said remote equipment by means of said communication interface of said monitoring device.

One advantage is to obtain information about a fluid passing within an equipment of a hydraulic system to correlate said information with the measurements made by the different sensors of the device. Another advantage is to be able to determine more precisely the origin of a possible leak.

In one embodiment, the remote equipment is configured to generate at least one command of at least one hydraulic equipment in response to the reception and processing of the physical parameter measured by the at least one water meter and transmitted to said remote equipment.

One advantage is to be able to offset an abnormal event such as a leak in the hydraulic circuit, by acting on a hydraulic equipment of said hydraulic circuit, for example by closing a solenoid valve.

In one embodiment, the sensor for detecting a physical parameter is a float level sensor, said float being arranged in said room and said float actuating an electrical, mechanical or magnetic contact to generate the production of an electrical current measured by said sensor. One advantage is to be able to determine the presence of a volume of water in the room by the displacement of said float in the direction of the electrical, mechanical or magnetic contact.

In one embodiment, the sensor for detecting a physical parameter is a conductivity measurement detector, said detection sensor comprising two contacts of an open electrical circuit and configured to detect an electrical current generated by the closing of the electrical circuit, said closing of the circuit being caused by the presence of a conductive volume of water. One advantage is to be able to determine the presence of a volume of water in the room by closing the electrical circuit of said detection sensor. Another advantage is to be able to follow the evolution of the presence of water in the room when several measurements are carried out successively.

In one embodiment, the sensor for detecting a physical parameter is an ultrasonic level sensor, said ultrasonic level sensor being arranged such that a signal emitted and reflected to the floor of the room is processed to deduce a volume of water present in the room. One advantage is to deduce, as a function of the distance travelled by the emitted and reflected signal, the presence of a volume of water in the room.

In one embodiment, the ultrasonic level sensor comprises a temperature probe, said temperature probe allowing a temperature of the room to be measured, said measured temperature being taken into account in the processing of the emitted and reflected signal to deduce the volume of water present in the room. One advantage is to take the temperature into account in the wave velocity measurement to obtain more accurate results.

In one embodiment, the sensor for detecting a physical parameter is a pressure sensor, said sensor comprising at least one element sensitive to a pressure exerted by a fluid on said sensor.

In one embodiment, the pressure sensitive element comprises at least one membrane, said membrane being arranged in a container or near the floor of the room such that a pressure value is measured to deduce the presence of a volume of water. One advantage is to be able to determine a presence of water in the room by measuring a pressure exerted on the membrane of said pressure sensor or by measuring a pressure difference between several membranes of said pressure sensor. Another advantage is to track the evolution of a presence of water in the room when several measures are implemented successively.

In one embodiment, the sensor for detecting a physical parameter is an optical sensor, said optical sensor being configured to acquire images of a part of the room, said monitoring device comprising a software component to automatically process the acquired images and deduce an element characteristic of the presence of a volume of water in said room. One advantage is to be able to determine more precisely the presence of water in the room from the processing of acquired images.

In one embodiment, the sensor for detecting a physical parameter is a humidity sensor, measuring a volume of water evaporated within said room. One advantage is to be able to determine the presence of water in the room with greater precision, by measuring a specific physical parameter.

In one embodiment, the monitoring device comprises a plurality of detection sensors, each sensor detecting different physical parameters, said monitoring device comprising a calculator for generating a reliability signal of the presence of a volume of water, said reliability signal being generated from a plurality of first signals. One advantage is to be able to detect with enhanced reliability the presence of a volume of water in the room.

In one embodiment, the monitoring device comprises an electrical meter for measuring an electrical consumption of a drainage system, an alert being emitted to the remote equipment by means of the communication interface when the electrical meter has read an electrical consumption below a predefined threshold, either:
during a first predefined time interval;
during a second predefined time interval after the emission of the first signal;
during a third predefined time interval after the emission of a command to actuate a first hydraulic equipment of the hydraulic system,
during a predefined cumulative time interval, said predefined cumulative time interval comprising a sum of several cumulative time intervals over a predefined period.

One advantage is to be able to alert a user in the event of a malfunction of an equipment of the device. Another advantage is that different criteria can be used to determine a malfunction of an equipment of the device.

In one embodiment, the communication interface is configured to receive a second signal from a third party electronic equipment in response to the first signal emitted to the remote equipment, said second signal comprising a command to actuate a second hydraulic equipment of the hydraulic system.

One advantage is to be able to remotely activate hydraulic equipment of the system following the detection of a volume of water in the room, for example a valve to shut off a water supply.

In one embodiment, the communication interface is configured to receive a third signal in response to the first signal emitted, said third signal comprising a command to acquire at least one image or at least one video sequence by at least one camera, said at least one image or video sequence being automatically transmitted to the remote equipment.

One advantage is to carry out a lifting of doubt video after the transmission of the first signal, to confirm or infirm the presence of a volume of water in the room.

In one embodiment, the monitoring device comprises a memory for recording data measured by at least one of the detection sensors, data measured by the electrical meter, images or video sequences acquired by the camera and/or data calculated by the calculator. One advantage is to be able to store within the device all of the information acquired by the various sensors and equipment.

According to another aspect, the invention relates to a system for monitoring a plurality of rooms comprising:
A plurality of monitoring devices;
A data server to record the first signals emitted by the monitoring devices;
A hardware resource defining an operating console comprising a display to generate a visual representation of a plurality of monitoring devices and generate a status indicator of each room associated with each monitoring device, said status indicator comprising a datum characteristic of the presence or not of a volume of water associated with each monitoring device.

According to one embodiment, the system comprises a memory for recording the history of events associated with said at least one room. One advantage is to be able to record the data acquired by the different sensors and/or the different equipment of at least one room of the system.

According to another aspect, the invention relates to a method for monitoring a room comprising the following steps:
Measurement of at least one physical parameter by means of at least one detection sensor;
Deduction of the presence of a volume of water in said room from the measured physical parameter;
Emission of a first signal when the volume of water deduced exceeds a predefined threshold;
Reception of a second signal in response to the emission of said first signal.

According to one aspect, the invention relates to a device for monitoring a room, said monitoring device comprising:
a plurality of detection sensors configured to measure a plurality of physical parameters, the values of which are characteristic of the presence of a volume of water in the room, each of said detection sensors being configured to measure a different physical parameter;
a calculator configured to:
   calculate a characteristic value of the volume of water from the physical parameters measured by the detection sensors;
   compare said characteristic value of said volume of water with at least one threshold value;
   generate a reliability signal from the measured physical parameters, said reliability signal allowing reliable detection of the presence of said volume of water in said room;
   a communication interface for emitting said reliability signal to at least one remote equipment when the characteristic value of the volume of water is greater than or equal to said threshold value.

According to one embodiment, at least one sensor for detecting a physical parameter is an ultrasonic sensor arranged to emit signals at regular time intervals towards a floor of said room, each emitted signal being reflected towards said ultrasonic sensor, said reliability signal being calculated as a function of a distance travelled or a travel time of said emitted and reflected signals.

According to one embodiment, the ultrasonic sensor is coupled to a temperature probe allowing a temperature of the room to be measured, said measured temperature being taken into account in the processing of the emitted and reflected signal to calculate the reliability signal.

According to one embodiment, at least one sensor for detecting a physical parameter is a float level sensor, said float being arranged in said room and said float actuating an electrical, mechanical or magnetic contact to generate the production of an electrical current measured by said sensor.

According to one embodiment, at least one sensor for detecting a physical parameter is a conductivity measurement detector, said detection sensor comprising two contacts of an open electrical circuit and configured to detect an electrical current generated by the closing of the electrical circuit, said closing of the circuit being caused by the presence of a conductive volume of water.

According to one embodiment, at least one detection sensor is a water meter configured to measure a physical parameter relative to a fluid passing through an equipment of a hydraulic system installed for at least a part in said room or in its proximity, counting information relative to said fluid passing through being sent to said remote equipment by means of the communication interface.

According to one embodiment, at least one sensor for detecting a physical parameter is a pressure sensor, said sensor comprising at least one element sensitive to the pressure exerted by a fluid on said pressure sensor.

According to one embodiment, at least one sensor for detecting a physical parameter is an optical sensor configured to acquire images of at least one part of the room, said monitoring device comprising a software component to automatically process the acquired images and deduce an element characteristic of the presence of the volume of water in said room.

According to one embodiment, at least one sensor for detecting a physical parameter is a humidity sensor measuring a volume of water evaporated within said room.

According to one embodiment, the reliability signal is generated by the calculator from at least two separate measurements performed by at least two separate detection sensors among:
an ultrasonic sensor arranged to emit signals at regular time intervals towards a floor of said room, each emitted signal being reflected to said ultrasonic sensor;
a humidity sensor measuring a volume of water evaporated within said room;
an optical sensor configured to acquire images of at least one part of the room;
a float level detector, said float being arranged in said room and said float actuating an electrical, mechanical or magnetic contact to generate the production of an electrical current measured by said sensor;
a conductivity measurement sensor comprising two contacts of an open electrical circuit and configured to detect an electrical current generated by the closing of the electrical circuit, said closing of the circuit being caused by the presence of a conductive volume of water;
a pressure sensor comprising at least one element sensitive to the pressure exerted by a fluid on said pressure sensor,
a water meter configured to measure a physical parameter relating to a fluid passing through an equipment of a hydraulic system installed for at least a part in said room.

According to one embodiment, the device for monitoring a room comprises the remote equipment configured to generate, in response to a reception and processing of said reliability signal, a command of at least one item of hydraulic equipment.

According to one embodiment, the hydraulic equipment is a solenoid valve.

According to one embodiment, the monitoring device for monitoring a room comprises a main container and a secondary container arranged in the room, said secondary container comprising means for allowing passage of a volume of water discharged into the main container to said secondary container when pressure is applied by said discharged volume of water on said means, at least one of the detection sensors of a physical parameter being placed in one of said containers to measure a physical parameter associated with said discharged volume of water, said detection sensor being configured to transmit in real time to the calculator said physical parameter and the calculator being configured to generate a command to activate at least one hydraulic equipment to vary, in one of said containers, the height of said discharged volume of water.

According to one embodiment, the device comprises an electrical meter for measuring electrical consumption values of a drainage system, the calculator being configured to compare said measured electrical consumption values with threshold values and to generate an alert being emitted to the remote equipment by means of the communication interface when said electrical meter has read an electrical consumption below a predefined threshold, either:
during a first predefined time interval;
during a second predefined time interval after the emission of the reliability signal;
during a third predefined time interval after the emission of a command to actuate a first hydraulic equipment of the hydraulic system,
during a predefined cumulative time interval, said predefined cumulative time interval comprising a sum of several cumulative time intervals over a predefined period.

According to one embodiment, the communication interface is configured to receive a second signal from a third party electronic equipment in response to the reliability signal emitted to the first remote equipment, said second signal comprising a command to actuate at least one lift pump to lower the volume of water in the room.

According to one embodiment, the communication interface is configured to receive a third signal in response to the emission of the reliability signal, said third signal comprising a command to acquire at least one image or at least one video sequence by at least one camera, said at least one image or video sequence being automatically transmitted to the remote equipment. According to one embodiment, the communication interface is configured to receive a fourth signal.

According to one embodiment, the communication interface is configured to receive the fourth signal comprising data transmitted by a monitoring device from at least one other room.

According to one embodiment, the communication interface is configured to receive the fourth signal comprising data transmitted by at least one equipment remote from the room.

According to one embodiment, the communication interface is configured to receive the fourth signal comprising meteorological data, data from a remote server, data from sensors positioned outside the room, or a combination of these data.

According to another aspect, the invention relates to a system for monitoring a plurality of rooms comprising:
A plurality of monitoring devices;
A data server to record the first signals emitted by the monitoring devices;
A hardware resource defining an operating console comprising a display to generate a visual representation of a plurality of monitoring devices and generate a status indicator of each room associated with each monitoring device, said status indicator comprising a datum characteristic of the presence or not of a volume of water associated with each monitoring device;
A memory to record the history of events associated with said at least one room.

According to another aspect, the invention relates to a method for monitoring a room comprising the following steps:
Measuring a plurality of different physical parameters by means of a plurality of detection sensors, each detection sensor measuring a different physical parameter;
Calculation, by a calculator, of a characteristic value of a volume of water present in the room from the measured physical parameters;
Comparison, by the calculator, of the characteristic value of the volume of water with at least one threshold value;
Generation, by the calculator, of a reliability signal from the measured physical parameters, said reliability signal allowing reliable detection of the presence of said volume of water in said room,
Emission, by a communication interface and to at least one remote device, of said reliability signal when the characteristic value of the volume of water is greater than or equal to said threshold value.

### BRIEF DESCRIPTION OF THE FIGURES

Other characteristics and advantages of the invention will become clearer upon reading the following detailed description, in reference to the appended figures, that illustrate:

FIG. 1: A monitoring device arranged within a room.

FIG. 2: A flow chart of the recording of a physical parameter and the transmission of a first signal.

FIG. 3: A monitoring device arranged in a room comprising a plurality of detection sensors.

FIG. 4: A flow chart of the generation and transmission of a plurality of alerts.

FIG. 5: A flow chart of the transmission of a signal and the reception of a plurality of signals by the communication interface.

FIG. 6: A system for monitoring a plurality of rooms.

FIG. 7: A representation of a main container and a secondary container comprising a lift pump

### DETAILED DESCRIPTION

### Room

According to a first aspect, with reference to FIG. 1, the invention relates to a monitoring device for monitoring a room 100. According to one case, the room 100 comprises a service room, for example within a building, such as a boiler room or an elevator. “Service room” is taken to mean a part of a building that comprises service equipment such as for example hydraulic equipment, heating equipment, electrical or electronic equipment or hydraulic circuits, heating circuits or electrical or electronic circuits. More generally, the room 100 may comprise any part of a building within which there are either hydraulic circuits likely to have one or more leaks, or within which there are equipment likely to be damaged by the presence of water. According to one case, the room 100 may comprise any part of a building within which there is a basin or manhole.

### Sensors

According to one embodiment, the monitoring device 1 comprises a detection sensor 20. The detection sensor 20 is configured to detect and measure a physical parameter 2. By way of example, the physical parameters measured by the detection sensor 20 may comprise values of pressure, temperature, speed, flow rate, volume or even humidity. The aforementioned examples are in no way limiting, and any type of physical parameter relating to the room 100, relating to equipment of the room 100, relating to a fluid present in the room 100 or relating to a fluid passing through equipment in the room 100 is capable of being measured by the detection sensor 20.

The measurements of different physical parameters using the detection sensors 20 aim for example to identify the presence of a volume of water 3 in the room 100. The presence of the volume of water 3 in the room 100 thus identified may then be linked to a cause, such as a leak in a hydraulic circuit or a natural cause such as a meteorological cause having led to flooding. In the remainder of the description, “volume of water 3” will be defined as a volume of water present in the room 100 following flooding, a leak, or even having been deliberately introduced into said room 100.

In the case of a plurality of leaks, flooding, etc., “volume of water 3” could designate for example two or more volumes of water in different rooms or in the same room, but having different origins. Several “volumes of water 3” designated by this same designation could correspond to different amounts of water as a function of the causes having led to their occurrence. This designation makes it possible in the description to designate the volumes of water from one or more flooding events, one or more leaks, etc. when they are identified and supervised by the same control member in the context of a multi-site operation of the invention.

According to one embodiment, the detection sensor 20 comprises a level sensor. The level sensor is for example a float level detector. According to one case, the float is arranged in the room 100 and actuates an electrical, magnetic or mechanical contact to generate an electrical current measured by said level sensor.

According to various embodiments, the level sensor may comprise a float switch, an ultrasonic level sensor such as a contact ultrasonic level sensor or even a non-contact ultrasonic level sensor. The ultrasonic level sensor is for example arranged so that a signal is emitted by the said sensor towards the ground. The signal is then reflected and the calculation of the travel time of said emitted and reflected signal makes it possible to deduce a distance between the ground and said detection sensor 20.

According to one embodiment, the measured distance is compared to a threshold value. For example, the measured distance is compared to a threshold value within a calculator configured to implement a comparison operation. This threshold value corresponds for example to the value of the distance between the floor and said detection sensor 20 when the room is dry. This implementation is particularly advantageous in the case where the volume of water 3 is present in the room 100. Indeed, if the measured distance value (which corresponds to the distance traveled by the signal emitted by the detection sensor 20) is less than the threshold value, it is deduced therefrom that an object or said volume of water 3 is between the ground and said detection sensor 20. The distance measurements are for example performed at regular time intervals at a predefined frequency. According to another example, the distance measurements are programmed to be automatically triggered according to certain conditions such as dates, events, etc. According to another example, the distance measurements are performed on request(s), for example following the emission of a request from a remote server supervising the ultrasonic sensor. This last request may be generated for a given case of this kind or it may be generated regularly at a predefined frequency. According to another case, these measurements are performed spontaneously following the emission of data from another sensor. One interest is to make the measurements reliable by corroborating them with other measurements.

The presence of the volume of water 3 may then be confirmed, for example by measurements made by other detection sensors 20 located in the room 100. Thus, the implementation of such a sensor is very advantageous to identify the presence of a leak or flooding in the room 100.

According to one embodiment, the detection sensor 20 is coupled to a temperature probe. The temperature probe is for example integrated into said sensor 20. In one alternative, the temperature probe is detached and independent of the detection sensor 20. The temperature probe makes it possible to measure a temperature of the room 100 at a given time. This implementation is particularly advantageous in the case where the detection sensor 20 comprises a sensor of which the measurements are influenced by temperature, such as an ultrasonic sensor. Indeed, the speed of sound depends on the temperature of the medium in which the wave moves. Therefore, the fact of correlating the measurement of this speed with a temperature value makes it possible to eliminate the risk of error and thus to obtain more accurate results.

According to one embodiment, the detection sensor 20 comprises a detector by conductivity measurement. According to an illustrative example, the detector by conductivity measurement comprises at least two electrical contacts, forming an open circuit. The presence of a volume of water between the two contacts then closes the circuit, within which a current starts to flow. The detection of a current circulating between the two contacts by the detection sensor 20 advantageously makes it possible to detect the presence of the volume of water 3 between the two contacts.

According to one embodiment, the detection sensor 20 comprises a pressure sensor. The pressure sensor is for example a differential pressure sensor. The pressure sensor may comprise a membrane or a plurality of membranes. According to one exemplary case, the pressure sensor comprises a plurality of membranes arranged at different positions in the room 100. One membrane is for example arranged at a predefined distance from the ground and the other membrane is for example arranged at ground level, or at the bottom of a basin. In one example, a measurement of a pressure differential between several membranes is performed, either continuously or at regular intervals. The measurements made by the pressure sensor may be programmed to be triggered automatically according to certain conditions such as dates, events, etc. or they may be made on request, for example following the emission of a request from a remote server supervising the pressure sensor. This last request may be generated for a given case of this kind or it may be generated regularly at a predefined frequency. In another case, these measurements are performed spontaneously following the emission of data from another sensor. One interest is to make the measurements reliable by corroborating them with other measurements.

The presence of a pressure differential between the membranes then makes it possible to deduce that a parameter influences the pressure at the level of one of said membranes, for example the volume of water 3 on the ground or the volume of water 3 in a basin. Thus, the installation of a pressure sensor in the monitoring device 1 is particularly advantageous for detecting a presence of water in the room 100.

In one embodiment, the detection sensor 20 comprises an optical sensor. The optical sensor comprises for example an image sensor such as a photo sensor or a video sensor. The optical sensor is for example implemented to acquire images or video sequences of the room 100. The images or video sequences obtained make it possible for example to confirm the presence of the volume of water 3 in the room 100 in addition to the measurements performed by other detection sensors 20.

In one embodiment, the optical sensor is configured to acquire images and/or video sequences of the room 100 at regular time intervals. In one alternative, the optical sensor is configured to acquire images and/or video sequences over predefined time ranges. According to another case, the optical sensor is configured to acquire images and/or video sequences in response to receiving an acquisition command. The acquisition command is for example transmitted from a remote equipment E₁ to the optical sensor. According to another example, the acquisition command is transmitted to the optical sensor from a calculator of the monitoring device. In an exemplary embodiment, the acquisition command is transmitted to the optical sensor by the calculator by means of a communication interface INT₁ when said calculator has processed data from a detection sensor 20 and information about the presence of a volume of water in the room has been determined by said processing. This is particularly advantageous to confirm the presence of a volume of water in the room 100, or to identify the position of a possible water leak from a hydraulic equipment located in said room 100.

In one embodiment, the optical sensor comprises at least one camera 7.

In one embodiment, at least one camera 7 comprises at least one optical sensor.

In one embodiment, the monitoring device comprises a user interface for real time access to images and/or video sequences acquired by the optical sensor. Real time access to images and/or video sequences is for example possible on request, said request being for example processed by a calculator to provide a refreshed image in real time of the room 100. The user interface comprises for example a screen to allow the user to view the images and/or video sequences acquired by the optical sensor in real time. One advantage is to allow a user to access the images and/or video sequences of the room 100 in real time. Another advantage is to ensure that the monitoring device has indeed detected the presence of water in the room at the time it appeared. For example, if the last image acquired by the optical sensor before the detection of a volume of water 3 in the room 100 does not show the presence of water, this signifies that the device has indeed detected the presence of the volume of water in the room 100 at the time of its appearance.

In one embodiment, the monitoring device comprises a software component to automatically process the acquired images and/or the acquired video sequences and deduce an element characteristic of the presence of a volume of water in said room. The characteristic element corresponds for example to a difference between the acquired image and an image of the room when it does not contain the volume of water 3. According to another example, the software component is configured to implement different filters on the acquired image, for example to identify particular frequencies that could correspond to the volume of water 3 on the image.

In one embodiment, the detection sensor 20 comprises a humidity sensor, sometimes referred to in the literature as a hygrometer. The humidity sensor is for example a capacitive humidity sensor or a resistive humidity probe. The humidity sensor is for example implemented to identify a volume of water evaporated in the room 100.

In one embodiment, the humidity sensor is coupled to a temperature probe. The temperature probe is for example integrated into the humidity sensor. According to another example, the temperature probe is detached and independent of said humidity sensor. This is particularly advantageous to increase the measurement accuracy in the case of the use of a resistive humidity probe. Indeed, the resistance of certain materials implemented in such a probe can vary with temperature. Thus, taking into account a temperature parameter advantageously makes it possible to increase the accuracy of the humidity measurement.

In one embodiment, the monitoring device comprises a plurality of sensors for detecting 20 a physical parameter. Each detection sensor 20 is for example configured to measure a different physical parameter. The detection sensors 20 implemented are for example different sensors, such as float level sensors, conductivity measurement sensors, ultrasonic sensors, optical sensors, pressure sensors, temperature probes or humidity sensors. This implementation is particularly advantageous to improve the accuracy of detection of a volume of water in the room 100.

According to one embodiment, a plurality of detection sensors 20 are arranged in the room 100 at different heights. The detection sensors 20 are for example located at different heights from the ground, a basin or a manhole. The detection sensors 20 are for example sensors of the same nature. The detection sensors 20 are for example level sensors. The arrangement of different level sensors at different heights in the room makes it possible to track the evolution of the water level in the room 100 by monitoring the exceeding of thresholds. This embodiment is particularly advantageous for tracking the evolution of a presence of water in the room 100 in real time. According to another example, the detection sensors 20 arranged at different heights from the floor, a basin, or a manhole are sensors of different natures, for example a membrane pressure sensor, an ultrasonic sensor, a level sensor and a conductivity measurement sensor. One advantage is to track the evolution of the presence of water in the room 100 more precisely, notably by combining discrete measurements and continuous measurements (exceeding thresholds for level sensors and evolution of the water height over time for pressure sensors and ultrasonic sensors).

According to one embodiment, the monitoring device comprises one or more water meters Cₑ. “Water meter Cₑ” is taken to mean a sensor or a set of sensors making it possible to measure a counting information 4 on a fluid passing within equipment of the device or a hydraulic system.

In one embodiment, at least one detection sensor 20 comprises a water meter Cₑ.

According to various embodiments, the measured counting information 4 comprises a volume, a flow rate, a flux or even a characteristic speed of a fluid passing within the hydraulic system. According to various examples, in order to measure the counting information 4, the water meter Cₑ comprises, a flux sensor, a speed sensor, a level sensor, or even a combination of several of these technologies among themselves. More generally, the counting information 4 may comprise any type of information relating to a fluid passing through or present within the room 100.

According to one embodiment, at least one water meter Cₑ comprises a flow meter. The implementation of one or more flowmeter(s) is advantageous for measuring the flow rate of one or more fluids passing within an equipment present in the room 100. More generally, the water meter Cₑ may comprise any type of means for measuring the amount of water circulating in a hydraulic circuit.

According to one embodiment, at least one detection sensor 20 comprises an acoustic sensor. The acoustic sensor is configured to convert the signal from a sound wave to an electrical signal. The sound wave comprises for example one or more sound frequencies characteristic of a leak in a hydraulic circuit. The acoustic sensor used comprises or example a piezoelectric type sensor or an electrostatic type sensor. However, the type of acoustic sensor implemented is not limited to the aforementioned examples, and any type of acoustic sensor is capable of being implemented within the scope of the invention according to the use cases. One advantage is to be able to accurately detect a leak in hydraulic equipment, for example as a function of an acoustic frequency characteristic of a leak in a pipe.

### Drainage System

According to one embodiment, the monitoring device 1 comprises a drainage system 11. “Drainage system” 11 is taken to mean one or more items of equipment capable of evacuating the volume of water 3 located inside the room 100. The equipment of the drainage system 11 comprises for example one or more lift pumps or one or more backflow pumps for draining the volume of water 3.

The installation of the drainage system 11 is particularly advantageous within the monitoring device 1 for leaks and flooding in the room 100. In this way, the device makes it possible to detect the problem, but also to remedy it, by evacuating said volume of water 3 present in said room 100.

According to one embodiment, the drainage system 11 comprises one or more water meters Cₑ. It is understood that the drainage system 11 “comprises” one or more water meters Cₑ by the fact that one or more water meters Cₑ are arranged near or within the drainage system 11. Such a water meter Cₑ is for example arranged at the inlet of a pump of the drainage system 11. “Inlet of a pump” is taken to mean the orifice at which the liquid is drawn in by said pump. Such an arrangement is of particular interest for measuring information on the volume of water drained by the drainage system 11 in the room 100. According to another example, one or more water meters Cₑ are arranged in an evacuation pipe of the drainage system 11.

In an exemplary embodiment, the information on the volume of water drained is compared with information on the volume of water 3 present in the room 100, for example by means of a comparison operation implemented by a calculator. One advantage is to be able to determine whether the entire volume of water 3 present in the room 100 has indeed been evacuated by the drainage system 11.

In one embodiment, the drainage system 11 comprises a plurality of pumps. The plurality of pumps comprises for example a plurality of lift pumps. One advantage is to optimize the evacuation of the volume of water present in the room, for example in the event of leakage or flooding.

According to one embodiment, the drainage system 11 comprises at least one primary pump and at least one secondary pump. “Primary pump” is taken to mean a pump intended primarily to evacuate a volume of water 3 present in the room 100, when the drainage system 11 operates normally. “Secondary pump” is taken to mean a pump intended to evacuate a volume of water 3 from the room 100 in the event of a malfunction of at least one primary pump. A secondary pump is for example put into operation when a malfunction of a primary pump of the drainage system 11 has been detected, for example when a volume of water 3 is detected in the room and an abnormal electrical consumption is recorded at the level of a primary pump supposed to ensure the evacuation of the volume of water 3. This abnormal electrical consumption is for example an electrical consumption below a predefined threshold or above a predefined threshold, either during a predetermined time interval or over a cumulative time interval, such as for example a total consumption measured over 24 hours. One advantage is to ensure that the volume of water 3 detected in the room is indeed evacuated by the drainage system 11. Thus, the implementation of one or more secondary pumps makes it possible to ensure better efficiency of the drainage system 11 and to offset the risks of non-evacuation or partial evacuation of the volume of water 3 in the event of malfunction of one or more primary pumps.

In one embodiment, a water meter Cₑ is arranged near each of the pumps of the drainage system 11. One advantage is to record the amount of water evacuated by each of the pumps of the drainage system 11. “Amount of water evacuated” is taken to mean the volume of water drained by each of the pumps of the drainage system 11 in the room 100.

In one embodiment, at least one hydraulic equipment of the device comprises a pump. The hydraulic equipment comprises for example a lift pump.

### Calculator

In one embodiment, the monitoring device 1 comprises the calculator K₁. The calculator K₁ is configured to process data measured by different detection sensors 20. According to one case, the calculator K₁ is implemented to process the data of one or more detection sensors 20 and deduce therefrom the presence of the volume of water 3 in the room 100.

In an illustrative example, a plurality of data from an ultrasonic sensor and a sensor by conductivity measurement is received by the calculator K₁. The travel time data of the wave emitted by the ultrasonic sensor are processed and compared with a threshold value in order to deduce therefrom whether the travel time of the emitted and reflected wave is less than said threshold value. The threshold value corresponds to the travel time of the wave when there is no obstacle between the ultrasonic sensor and the ground. The information from this comparison is then compared with the information emitted by the sensor by conductivity measurement, which for example has read a current flowing between its two terminals. Information on the presence of the volume of water 3 in the room 100 is then determined precisely.

According to various embodiments, several measurements from a plurality of detection sensors 20 are processed by the calculator K₁. Advantageously, information on the presence of the volume of water 3 in the room is then determined with an accuracy correlated with the number of data received by the calculator K₁.

In one embodiment, the calculator K₁ comprises a memory. The memory comprises for example the RAM of the calculator K₁. According to one case, the calculator K₁ records the data from several detection sensors 20 within said memory. This data comprises for example measurements of different physical parameters 2 such as temperature, pressure, speed, humidity measurements or time values such as timestamp values of the reception of said data by the calculator K₁.

According to one embodiment, the calculator K₁ records data derived from the processing of data from the different detection sensors 20. In an illustrative example, the data from the detection sensors 20 are processed by the calculator to determine the presence of a volume of water in the room 100. The data may also be processed to evaluate the amount of water present in the room 100. For example, the measurement of the travel time of the wave emitted by an ultrasonic sensor makes it possible to determine a distance between said ultrasonic sensor and an obstacle materialized by the volume of water 3. It is then possible to estimate the height of the volume of water 3 on the ground in the room 100 by comparing said distance with the distance to the ground of the ultrasonic sensor when no volume of water is present in the room 100. According to another example, the float level sensors make it possible to measure directly the water level. Thus, the float sensors make it possible to obtain information on the exceeding of a predefined threshold, and the ultrasonic sensors make it possible to track the evolution of the presence of water in the room 100 by implementing successive measurements to evaluate the distance of said volume of water to said sensor and hence the water height in the room 100.

In one embodiment, the calculator K₁ is configured to generate a first signal S₁. The first signal S₁ is for example generated in response to the detection of the volume of water 3 by one of the detection sensors 20. In an illustrative example, a conductivity measurement detection sensor detects a current flowing at its terminals. Information relative to the current flowing is then transmitted to the calculator K₁, which is then going to generate the first signal S₁.

According to different embodiments, the first signal S₁ comprises a plurality of data among the data measured by the detection sensors 20, one or more timestamp data of the reception of said data by the calculator K₁ or data from different probes such as temperature or pressure probes.

In one embodiment, the first signal S₁ comprises data derived from the processing, by the calculator K₁, of data measured by one or more detection sensors 20. These processing data comprise for example data relating to the presence of the volume of water 3 in the room 100.

In one embodiment, the calculator K₁ is configured to generate an anomaly information when a sensor has not transmitted data during a predefined time interval. According to various examples, the predefined time interval may comprise a simple time interval or then a cumulative time interval, for example over a predefined time range. According to an illustrative example, the predefined time range corresponds for example to 24 hours and the cumulative time interval to one hour. Thus, in this example, the calculator K₁ is configured to generate the anomaly information if the detection sensor has not transmitted information during a cumulative hour over a time range of 24 hours.

In one embodiment, the calculator K₁ is configured to generate a command to actuate the drainage system 11. This actuation command is for example generated in response to the reception of one or more data transmitted by the detection sensors 20. According to another example, the actuation command is generated following the processing of a data set by the calculator K₁ to determine the presence of the volume of water 3 in the room 100.

In one embodiment, the calculator K₁ is configured to generate a reliability signal from a plurality of first signals S₁. Each signal S₁ is for example transmitted to the calculator K₁ by different detection sensors 20 of the device. “Reliability signal” is taken to mean a signal comprising one or more items of information derived either from physical parameters measured by the detection sensors 20 or from the processing of these parameters by the calculator K₁. One advantage is to be able to reliably determine the presence of a volume of water in the room 100.

In one embodiment, the calculator K₁ is configured to generate a command to actuate a hydraulic equipment in response to the reception and processing of one or more received data. The data received are for example data acquired by one or more detection sensors 20 of the room 100. The processing of this data by the calculator K₁ makes it possible for example to deduce the presence of a volume of water 3 in the room 100. The hydraulic equipment actuated by the command generated by the calculator K₁ is for example a solenoid valve. One advantage is to be able to automatically shut off the circulation of water in a hydraulic equipment present in the room 100 when the presence of water is detected in the room 100. Thus, if this presence of water is due to a leak from a hydraulic equipment of the room 100, one advantage is to stop the evolution in the amount of water in the room 100. Another advantage is to determine more precisely the origin of the presence of the volume of water 3 in the room 100. Indeed, if the automatic cut-off does not make it possible to stop the evolution in the amount of water in the room 100, and if the sensors read for example an evolution in this amount, it is deduced therefrom that the presence of the volume of water 3 in the room 100 is due to an external factor, for example a meteorological cause.

### Leakage Detection

In one embodiment, at least one datum received by the calculator K₁ comprises a water consumption datum acquired by at least one water meter Cₑ. The water consumption datum comprises for example the metering information 4 measured by a flowmeter. In one embodiment, the calculator K₁ is configured to implement one or more operations for comparing said water consumption data with one or more threshold value(s). This comparison is for example a comparison of one or more value(s) resulting from the processing by the calculator K₁ of one or more water consumption data transmitted by one or more water meter(s) Cₑ. For example, the calculator K₁ can receive data from a water meter Cₑ located in a pipe of a hydraulic circuit installed for all or part in the room 100. The water consumption data are for example transmitted at regular intervals at a predefined frequency to the calculator K₁ by a communicating water meter Cₑ. According to another example, at least one water meter Cₑ comprises calculation means for comparing a water consumption datum measured by said sensor with a predefined value. In this case, the data are for example transmitted to the calculator K₁ if said data exceed the predefined threshold value. The water consumption data received are for example stored in a memory of the calculator K₁.

In one embodiment, a command to activate a hydraulic equipment is generated by the calculator K₁ when a threshold of water consumption data received is exceeded. The commanded hydraulic equipment is for example a solenoid valve. “Threshold of water consumption data” is taken to mean a numerical value corresponding to a number of data received. In one example, the number of data received is four and corresponds to four “data groups” received, for example in the case where a water consumption threshold value has been exceeded four times within a predefined time range. This implementation is advantageous notably when the water meter Cₑ comprises means of calculation. Indeed, if the comparison of the numerical value of the water consumption data is carried out at the level of said water meter Cₑ, the comparison threshold value is for example defined such that the data transmitted only correspond to “abnormal” water consumption. The command to activate a hydraulic equipment is for example generated by the calculator K₁ when the number of data received (by the calculator K₁) exceeds a numerical threshold over a predefined time range, for example 24 h, or over a predefined time range in specific time slots, for example between 23:00 and 6:00 am. One advantage is to monitor “abnormal” water consumption at night. Indeed, a regular or constant consumption of water over a night time range is a good indicator of a risk that a leak is present at the level of a hydraulic equipment of the monitoring device 100.

In one embodiment, a command to activate a hydraulic equipment is generated by the calculator K₁ as a function of the result of at least one comparison of a value of a water consumption data with one or more threshold values. At least one threshold value is for example substantially equal to the average of the water consumptions read by at least one water meter Cₑ over one or more predefined time range(s). According to another example, the calculator K₁ is configured to calculate a percentage of the value of at least one water consumption data compared to at least one threshold value. In this case, the command to activate at least one hydraulic equipment is for example generated by the calculator K₁ when the value of the water consumption data exceeds the threshold value by a predefined percentage. For example, the command to activate the hydraulic equipment is generated by the calculator K₁ if at least one water consumption value is greater than at least one threshold value. In another example, the command to activate at least one hydraulic equipment is generated by the calculator K₁ when at least one water consumption data is below at least one threshold value. One advantage is to be able to determine an abnormal water consumption in a hydraulic circuit as a function of an average of the consumptions passed over a predefined time range in said hydraulic circuit.

In an exemplary embodiment, three water meters Cₑ are arranged in a part of the hydraulic equipment which comprises a main pipe separating into two secondary pipes at one of its ends. A water meter Cₑ is arranged in the main pipe and a water meter Cₑ is arranged in each of the secondary pipes. The secondary pipes are for example smaller in diameter than the main pipe. A volume of water circulates in the main pipe and said volume of water divides at the end of said main pipe to partially circulate in each of the secondary pipes, such that the initial volume of water that circulated in the main pipe corresponds to the sum of the volumes of water circulating in the two secondary pipes. Each water meter Cₑ is for example configured to measure a datum relative to the volume of water passing through, for example a flow rate information. According to one case, each water meter Cₑ transmits at regular intervals and at a predefined frequency the data relating to the volume of water passing through to a calculator, for example the calculator K₁. The calculator is for example configured to implement a comparison operation between said values, such as a comparison of the sum of the numerical values of the data measured by the water meters Cₑ installed in the secondary pipes with the numerical value of the data measured in the main pipe. According to one case, the calculator is configured to apply a mathematical operation to at least one numerical value of a datum received by said calculator, for example to take into account the different sensitivity of each water meter Cₑ. According to another case, each water meter Cₑ is configured upstream such that no corrective action is necessary to make comparisons between the data measured by said water meters Cₑ and transmitted to the calculator. According to one case, the calculator is configured to generate a command to activate a hydraulic equipment, for example a solenoid valve, when an acceptability threshold value is exceeded corresponding for example to a maximum acceptable difference between the two values compared. According to another example, the data measured by each water meter Cₑ are sent to the equipment E₁ by means of a communication interface and the data are compared on a remote server. In this case, a command to activate a hydraulic equipment, such as a solenoid valve, is for example generated at the level of the remote server and transmitted to a communication interface of the device configured to receive said command.

### Electricity Consumption Measurement

In one embodiment, with reference to FIG. 3, the device comprises an electrical meter 6. The electrical meter 6 is implemented to measure the electrical consumption of one or more apparatuses of the monitoring device 1. One advantage is to be able to estimate the overall electrical consumption of the device. Another advantage is to be able to determine malfunctions within the device, for example when one or more items of equipment have not consumed electricity for a predetermined duration

In one embodiment, the electrical meter 6 is configured to measure an electrical consumption of at least one item of equipment of the drainage system 11. According to one example, an electrical consumption of a lift pump is measured by means of the electrical meter 6. According to another example, the electrical consumption of a plurality of pumps is measured by means of the electrical meter 6. One advantage is to determine whether the elements of the drainage system 11 function correctly to evacuate the volume of water 3 present in the room 100.

In one embodiment, the electrical meter 6 is configured to measure the electrical consumption of at least one electrically powered detection sensor 20. One advantage is to ensure the proper operation of all the sensors of the device, to ensure the presence of the volume of water 3 in the room 100 is detected.

In one embodiment, the electrical meter 6 is configured to measure the electrical consumption of the monitoring device 100. One advantage is to ensure the proper operation of the entire device, to ensure the presence of the volume of water 3 in the room 100 is detected.

In one embodiment, the electrical meter 6 is configured to measure the electrical consumption 6 of at least one item of electrically controlled or powered hydraulic equipment, for example a second hydraulic equipment 13. The second hydraulic equipment 13 comprises for example a solenoid valve. The electrical consumption of the hydraulic equipment is for example measured over a predefined time interval. One advantage is to track the electrical consumption of one or more items of equipment over time. Another advantage is to be able to check the proper operation of said equipment, for example following the receipt of a command to activate said equipment.

In one embodiment, the electrical meter 6 comprises a communication interface. The communication interface of the electrical meter 6 is implemented to transmit consumption information C_{elec} to at least one other equipment, for example an equipment of the device or a remote equipment E₁. The consumption information C_{elec} comprises for example one or more consumption readings of one or more items of equipment of the monitoring device 1, such as electrical consumption readings over time of the detection sensors 20 or electrical consumption readings of the pumps of the drainage system 11.

In one embodiment, the consumption information C_{elec} is transmitted by means of the communication interface by means of a wired link. In one alternative, the consumption information C_{elec} is transmitted by means of a wireless connection. The wireless connection comprises for example a connection via a Bluetooth, WI-FI, 2G, 3G, 4G, 5G or LoRa system. However, the aforesaid examples are given by way of indication and are in no way limiting. In reality, any type of suitable means of communication is capable of being implemented in the device to transmit the consumption information C_{elec}.

In one embodiment, the consumption information C_{elec} is transmitted to the calculator K₁ by means of the communication interface. The consumption information C_{elec} is for example processed by the calculator K₁ to deduce an operating status of the equipment of the monitoring device 1.

In one embodiment, the calculator K₁ is configured to generate a command to activate an equipment of the drainage system 11 when the electrical meter 6 has read an electrical consumption information C_{elec} lower than a predefined threshold. The activation command is for example implemented to start a lift pump of the drainage system. The activation command is implemented for example when the electrical consumption of a lift pump of the drainage system 11 is below a predefined threshold. One advantage is to activate another lift pump when the device detects a potential malfunction of one of the lift pumps of the drainage system 11.

In one embodiment, the command to activate an equipment of the drainage system 11 is generated following the reception of an image and/or a video sequence by the calculator. The activation command is for example generated automatically following the processing of images and/or video sequences by the calculator K₁ or by a software component of one of the cameras 7. According to another example, the activation command is received by the calculator from the remote equipment E₁. One advantage is to activate another lift pump when the acquisition of images or video sequences has made it possible to identify a malfunction of one of the pumps of the drainage system 11.

According to one embodiment, the generation of the signal S₁ by the calculator automatically causes the generation of a command to activate the drainage system 11. One advantage is to be able to automatically evacuate the volume of water 3 present in the room 100 following the detection of the latter by one or more detection sensors 20.

### Communication Interface

In one embodiment, the monitoring device 1 comprises a communication interface INT₁. The communication interface INT₁ makes it possible for example to exchange data with remote equipment E₁ such as equipment of a data network, for example a server.

According to one embodiment, the communication interface INT₁ comprises the communication interface of the electrical meter.

According to one embodiment, the equipment E₁ forms part of the monitoring device 1. In one alternative, the equipment E₁ is equipment remote from the device. Thus, according to various examples, the remote equipment E₁ may comprise equipment of a data network, a remote server, remote equipment comprising a user interface, for example a tablet or a mobile phone, or the calculator K₁ of the device. One advantage is to be able to exchange data from sensors, such as water consumption data, both within the monitoring device, but also with equipment that is located outside the device.

“Exchanging data” is taken to mean that the communication interface INT₁ may be used both as an emitter and as a receiver within the monitoring device 1. Thus, according to different exemplary embodiments, data may be emitted by the communication interface INT₁ to another equipment and data emitted by an equipment may be received by the communication interface INT₁ of the device.

According to one embodiment, the communication interface INT₁ communicates with the remote equipment E₁ by means of a wired link.

According to another embodiment, the communication interface INT₁ communicates with the remote equipment E₁ by means of a wireless connection. The wireless connection comprises for example Bluetooth, WI-FI, LoRa, 2G, 3G 4G or 5G technology.

According to one embodiment, the communication interface INT₁ communicates with the remote equipment by means of a “hybrid” architecture. “Hybrid” architecture is taken to mean a combination of wired and wireless connection means.

According to one embodiment, the communication interface INT₁ is configured to transmit the first signal S₁ generated by the calculator K₁. The first signal S₁ is for example emitted by the communication interface INT₁ to the remote equipment E₁.

In one embodiment, the remote equipment E₁ comprises means for decoding the information contained in the first signal S₁. One advantage is to allow the reception and processing of the information contained in the first signal S₁ by the same equipment.

In one embodiment, the counting information 4 is sent to the remote equipment E₁ by means of the communication interface INT₁. The counting information 4 is for example transmitted within the first signal S₁. According to another case, the counting information 4 is transmitted independently of the first signal S₁ to the remote equipment E₁.

In one embodiment, the electrical consumption information C_{elec} of the electrical meter 6 is transmitted by means of the communication interface INT₁ to the remote equipment E₁.

In one embodiment, an alert A₁ is emitted by means of the communication interface INT₁ when a presence of water is detected in the room 100.

In one embodiment, an alert A₁ is emitted by means of the communication interface INT₁ when an electrical consumption of an equipment is below a predefined threshold. The alert A₁ is for example emitted to the remote equipment E₁. The alert A₁ is for example emitted to the remote equipment E₁ within the first signal S₁. According to another example, the alert A₁ is emitted to the remote equipment E₁ independently of the first signal S₁. The comparison of the electrical consumptions with the predefined thresholds is for example implemented by the calculator K₁. Different consumption thresholds may be defined as a function of the equipment for which the electrical consumptions are read. According to various examples, the consumption information C_{elec} is measured for the detection sensors 20, the temperature probes, the equipment of the drainage system 11 or even one or more items of hydraulic equipment electrically powered or controlled such as one or more solenoid valves.

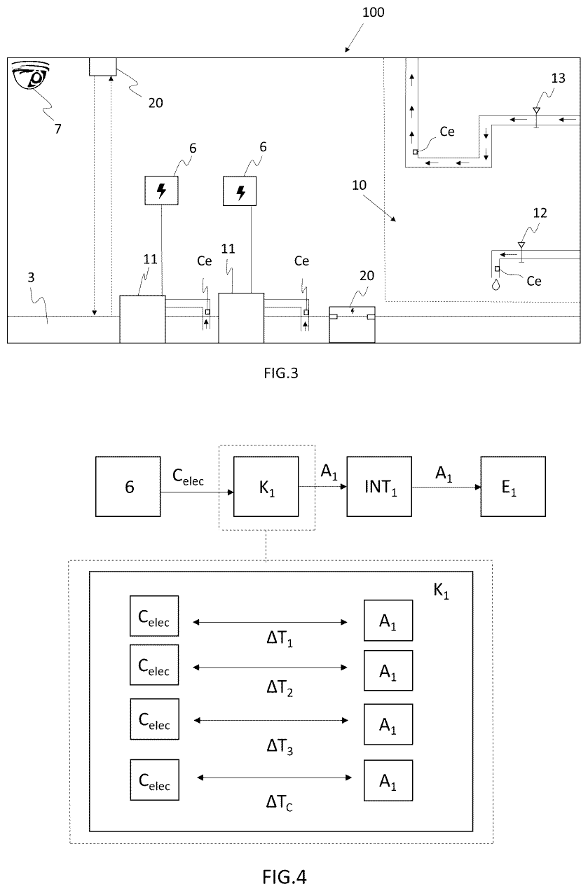

In one embodiment, with reference to FIG. 4, an alert A₁ is emitted to the remote equipment E₁ by means of the communication interface INT₁ when the electrical meter 6 has read an electrical consumption below a predefined threshold during a first time interval ΔT₁. The first time interval ΔT₁ corresponds for example to a threshold below which an equipment is considered to have a malfunction if its electrical consumption is below said predefined threshold.

In one embodiment, the alert A₁ is emitted to the remote equipment E₁ by means of the communication interface INT₁ when the electrical meter 6 has read an electrical consumption below a predefined threshold during a second time interval ΔT₂ after the emission of the first signal S₁. The second time interval ΔT₂ corresponds for example to a time interval during which an equipment of the device should have been triggered after the emission of the first signal S₁. By way of example, the first signal S₁ is emitted to a remote equipment and comprises measurement readings made by means of the detection sensors 20. The first signal S₁ is processed by the remote equipment E₁ to determine the presence of the volume of water 3 in the room 100. Therefore, a command to activate the drainage system 11 is received, for example by means of the communication interface INT₁. If, beyond the second time interval ΔT₂, an electrical consumption below a predetermined threshold value is identified for the drainage system 11, then an alert A₁ is emitted to indicate a malfunction of the system. The alert A₁ is for example emitted to the remote equipment E₁ by means of the communication interface INT₁. This embodiment is particularly advantageous to warn of a system malfunction in real time when a leak or flooding of the room 100 is identified.

In one embodiment, the alert A₁ is emitted by means of the communication interface INT₁ when the electrical meter 6 has read an electrical consumption below a predefined threshold during a third time interval ΔT₃ after the emission of a command to actuate a first hydraulic equipment 12 of a hydraulic system 10. The first hydraulic equipment 12 corresponds for example to a valve such as a solenoid valve or even a control valve. In one embodiment, the first hydraulic equipment 12 is actuated to discharge the volume of water 3 into the room 100. In one alternative, the volume of water 3 is discharged into a container present in said room 100. The container comprises for example one or more detection sensors 20. For example, an actuation command is transmitted to the drainage system 11 to evacuate said volume of water 3 discharged into the room 100 or into the container. If the electrical consumption of the drainage system 11 is less than the predefined threshold during the duration of the third time interval ΔT₃, the alert A₁ is emitted to signify the malfunction of said drainage system 11. One advantage is to be able to test the proper operation of an equipment of the device by deliberately discharging the volume of water 3 into the room 100.

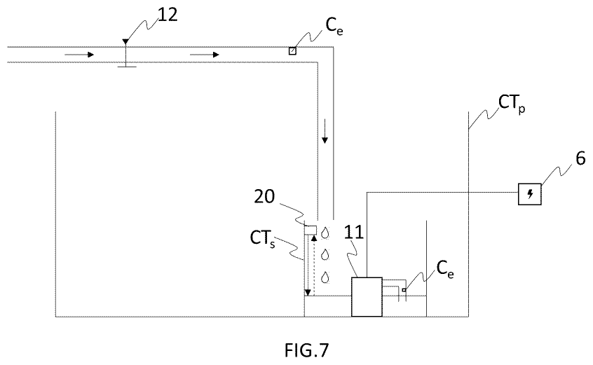

According to one embodiment, with reference to FIG. 7, the volume of water 3 is discharged into a secondary container CTₛ placed in a main container CTₚ present in the room 100. “Main container CTₚ” and “secondary container CTₛ” are taken to mean entities intended to contain a liquid volume, liquid or gaseous, for example a volume of liquid water. Such containers comprise for example one or more sensor(s), for example one or more detection sensor(s) 20, arranged therein to measure one or more physical parameter(s) related to the environment or to a volume discharged into one of said containers. The secondary container CTₛ comprises for example means for allowing the infiltration of water from a part of the main container CTₚ to the secondary container CTₛ. Such means comprise for example flaps configured to open in a single direction when pressure is applied to a portion of said flaps (for example the pressure exerted by a volume of water discharged into the main container CTₚ). One advantage is to be able to test the proper functioning of an equipment of a monitoring device, such as for example a lift pump, by discharging a smaller volume of water 3 into the secondary container CTₛ.

In one embodiment, the alert A₁ is emitted by means of the communication interface INT₁ when an electrical consumption greater than a predefined threshold has been measured by the electrical meter 6 (either during a predefined time interval, or over a cumulative time interval over a predefined period, for example 24 hours). One advantage is to be able to identify that one or more items of equipment of the device consume more energy than they should, for example a pump of the drainage system 11. Another advantage is to determine if the equipment of the device requires maintenance or inspection.

According to one embodiment, one or more images and/or video sequences are automatically and spontaneously transmitted to the remote equipment E₁ by means of the communication interface INT₁ when the alert A₁ is transmitted by said communication interface INT₁. One advantage is to provide a user with a view of the room 100 when a potential malfunction is identified. For example, if the images and/or video sequences show that the room 100 is flooded after transmission of the alert A₁, it may mean that one or more pumps of the drainage system 11 are defective.

According to one embodiment, one or more images and/or video sequences are transmitted to the remote equipment E₁ at a predefined frequency by means of the communication interface INT₁. The images and/or video sequences are for example transmitted to the remote equipment every minute. One advantage is to allow a user to consult a history of the images acquired from the room 100. Another advantage is to allow a user to view the last images and/or video sequences acquired at the time of reception of an alert A₁, for example to observe the presence of the volume of water 3 in the room 100.

In one embodiment, the alert A₁ is emitted to the remote equipment E₁ by means of the communication interface INT₁ when the electrical meter 6 has read an electrical consumption below a predefined threshold during a cumulative time interval ΔT_{C}. “Cumulative time interval ΔT_{C}” is taken to mean a time interval comprising a sum of several time intervals over a predetermined range. As an example, the cumulative time interval ΔT_{C} may correspond to a reading of periods during which the electrical consumption of an equipment has been below a predetermined threshold over a period of 24 hours. For example, if an equipment of the device has not operated for a total cumulative time of one hour over a period of 24 hours, then the alert A₁ is issued to indicate a malfunction of said equipment of the monitoring device 1.

According to one embodiment, the alert A₁ is emitted to the remote equipment E₁ by means of the communication interface INT₁ when a pump of the drainage system 11 operates during a period of time greater than a predefined time interval. Advantageously, an overuse of a pump of the drainage system 11 may be detected, so as to identify or predict a failure of said pump due to too excessive use which may lead to a reduction in its efficiency and/or its service life. Another advantage of detecting or predicting such a malfunction is to be able to put in place corrective actions such as repairing said malfunctioning pump or even replacing said malfunctioning pump with another pump, for example with a pump with a higher flow rate or a pump with substantially equivalent flow rate, or even equipping the monitoring device with a secondary pump.

In one embodiment, the communication interface INT₁ is configured to receive a second signal S₂ in response to the emission of the first signal S₁ emitted to the remote equipment E₁. The second signal S₂ is for example a signal emitted by a third party electronic equipment. The second signal S₂ may also be emitted by the remote equipment E₁ to which the first signal S₁ has been transmitted. In one embodiment, the second signal S₂ comprises a command to activate an equipment of the monitoring device 1. The activation command comprises for example a command to activate an optical sensor or a camera 7. The second signal S₂ is for example transmitted via a third party equipment to the communication interface INT₁ of the monitoring device 1. The third party equipment is for example a communicating equipment comprising a user interface. It is for example the remote equipment E₁ in an embodiment wherein said remote equipment E₁ comprises a user interface to allow a user to receive signals, alerts or even notifications transmitted from the communication interface INT₁ and to transmit commands to said communication interface INT₁. One advantage is to allow a user to perform a remote lifting of doubt video in the event of reception of the alert A₁. Another advantage is to allow a user to act remotely on the monitoring device 1, for example to send a command to open or close a valve or to remotely activate an equipment of the drainage system 11.

According to another exemplary embodiment, the second signal S₂ comprises a command to actuate a second hydraulic equipment 13 of the hydraulic system 10. The second hydraulic equipment 13 comprises for example a valve such as a balancing valve or a solenoid valve. One advantage is to be able to shut off the circulation of water in a part of the hydraulic system 10 when the presence of the volume of water 3 in the room 100 has been detected. Thus, if a leak is at the origin of the presence of the volume of water 3 in the room, the actuation of the second hydraulic equipment 13 advantageously makes it possible to shut off the water supply in the direction of the leak, for example the time to repair it and evacuate the volume of water 3 present in the room 100.

In one embodiment, a command to actuate a hydraulic equipment is automatically generated following the generation of the first signal S₁ by the calculator K₁. One advantage is to be able to spontaneously shut off the water supply of an equipment of the hydraulic system 10 or the monitoring device 1 when a characteristic measurement of the presence of the volume of water 3 in the room 100 has been carried out.

In one embodiment, with reference to FIG. 5, the communication interface INT₁ is configured to receive a third signal S₃ in response to the first signal S₁ emitted. The third signal S₃ is for example emitted by a third party electronic equipment or by the remote equipment E₁. The third signal S₃ comprises for example a command to acquire at least one image and/or at least one video sequence by at least one camera 7. In one embodiment, the acquisition of the at least one image and/or the at least one video sequence is performed by a detection sensor 20 comprising an optical sensor. One advantage is to be able to check the presence of water in the room 100 when a physical parameter 2 has been measured by at least one detection sensor 20 and transmitted by means of the first signal S₁.

In one embodiment, the communication interface INT₁ is configured to receive a fourth signal S₄. The fourth signal S₄ comprises for example data from remote equipment outside the monitoring device. This may be for example meteorological data transmitted from a weather station, data from a data server, for example comprising information on flood risks, or data from probes or sensors positioned outside the room 100. The fourth signal S₄ is for example processed by the calculator K₁ to deduce therefrom context information. The context information corresponds for example to information on weather conditions. One advantage is to be able to take into account parameters external to the system to determine the causes of the presence of the volume of water 3 in the room 100.

In one embodiment, the fourth signal S₄ comprises data transmitted by an equipment of a monitoring device 1 of at least one other room 100. The data are for example transmitted within the fourth signal S₄ in the form of .csv files, also referred to as a “comma separated value file” in the English literature. One advantage is to be able to take into account parameters measured within other rooms to identify the causes of the presence of water in the room 100. Another advantage is to be able to implement a prevention system within the room 100. For example, if several rooms have been flooded due to the malfunction of similar equipment, preventive maintenance can be implemented in the rooms that have not yet been flooded to control said equipment and thus prevent a risk of leakage or possible flooding. Another advantage is not to implement pump testing of the lift system in rooms in which the risk of flooding is significant to ensure the availability of all the equipment of the drainage system 11.

According to one embodiment, the second signal S₂ and/or the third signal S₃ is emitted in response to the acquisition of data by the remote equipment E₁. The acquired data are for example meteorological data transmitted from a weather station, data from a data server such as data comprising information on flood risks, or data from probes or sensors positioned outside the room 100. This information is for example transmitted to the equipment E₁ in the form of “.csv” files. The data are for example transmitted to the equipment E₁ by means of a Rest API provided by the equipment E₁ or by any other equipment having said data. The data are for example processed by a calculator of the remote equipment E₁ to deduce therefrom context information. The context information comprises for example information on weather conditions. One advantage is to take into account parameters external to the system to determine the causes of the presence of the volume of water 3 in the room 100.

According to one embodiment, the communication interface INT₁ is configured to transmit different types of notifications to the remote equipment as a function of a command generated by the calculator K₁. The calculator K₁ generates for example different notifications as a function of the data received by one or more detection sensors. For example, if the calculator receives a single detection of a sensor present in the room 100, a “minimum” level notification may be generated to indicate that the presence of water in the room is still to be confirmed, whereas a “maximum” level notification is generated if, in addition, a malfunction of a pump, for example a lift pump, is detected. According to another example, the calculator K₁ generates a “maximum” level notification when it receives several data from the same detection sensor 20 or from different detection sensors 20 or even when the data received and processed by said calculator K₁ have made it possible to deduce the presence of a significant volume of water 3 in the room 100. One advantage is to define different types of notifications as a function of their degree of relevance, for example to avoid making demands on a user too frequently in the event that the presence of water in the room is not necessarily proven.

In one embodiment, at least one notification is transmitted within the first signal S₁.

According to one embodiment, the notifications generated by the calculator are transmitted in the form of SMS alerts or even email alerts. In this case, the remote equipment E₁ is for example a mobile phone of a user or even a remote data server.

According to one embodiment, the notifications are generated by the remote equipment E₁. In this case, the remote equipment E₁ comprises for example a remote server. The notifications are for example based on one or more data, signals or alerts received by the remote equipment E₁, for example transmitted by means of the communication interface INT₁. According to another example, the notifications are based on information from an equipment external to the device and received by the equipment E₁, such as for example meteorological data transmitted by a weather station. According to another example, the notifications are generated by the remote equipment E₁ on the basis of received data transmitted by the communication interface INT₁ and received data transmitted by an equipment external to the monitoring device.

According to one embodiment, at least one alert A₁ comprises a notification.

According to one embodiment, at least one notification comprises an alert A₁.

### Filling a Container

In one embodiment, at least one detection sensor 20 is arranged in a container placed in the room 100. The container is for example placed under a water inlet of the room 100, for example under the first hydraulic equipment 12. At least one detection sensor 20 is for example positioned at a predefined height in the container to measure a datum relating to a volume of water discharged into the container via the water inlet.

In an exemplary embodiment, a volume of water is gradually discharged into a first container, said first container being arranged in a second container of larger size. “Volume of water” discharged into the container is taken to mean a variable volume of water in the sense that said volume of water changes as a function of the filling of the container. Thus, the term “volume of water” shall designate the volume of water present in one of the containers at a given time as a function of the filling of said container. The first and second containers are for example the secondary container CTₛ and the main container CTₚ respectively or different containers. The volume of water is for example discharged into the first container via the first hydraulic equipment 12 which comprises a solenoid valve. The first container comprises for example means for allowing the infiltration of a volume of water. Such means comprise for example flaps configured to open in a single direction from the second container to the first container, when a pressure is applied to a portion of said flaps (for example the pressure exerted by a volume of water discharged into the second container.) An ultrasonic measuring sensor is arranged in the upper part of the first container to measure in real time the evolution of the volume of water in said first container. The ultrasonic measuring sensor is configured to transmit information about the measured water level in the first container to the calculator K₁ in real time. The calculator generates commands as a function of predefined thresholds of heights exceeded by the volume of water in the first container. A first threshold corresponds to the activation threshold of a pump of the drainage system 11, the inlet of which is positioned in the first container and the electrical consumptions of which are measured by means of an electrical meter 6. The “inlet” of the pump is taken to mean the orifice through which the pump drains the volume of water into the first “container”. When this first threshold is exceeded by the volume of water in the first container, the calculator automatically generates a solenoid valve closing command. If an electrical consumption of the drainage system 11 lower than a predetermined threshold value is identified between the time when the first threshold is reached and the time when a second threshold lower than the first threshold is reached, it is considered that the pump of the drainage system 11 has a malfunction and an alert A₁ is for example emitted to the remote equipment E₁ via the communication interface INT₁. According to one case, a time interval is measured between the exceeding of the first threshold by the volume of water and the exceeding of the second threshold by said volume of water. The time interval is then compared with a threshold value, for example by means of the calculator K₁. If the compared time interval is greater than the threshold value, it is deduced therefrom that the pump of the drainage system 11 has a malfunction. If a third predefined threshold, greater than the first threshold, is exceeded by the volume of water, the calculator K₁ is configured to generate an alert, for example the alert A₁, and to activate a secondary pump of the drainage system 11, to evacuate all or part of the volume of water present in the first container. One advantage is to be able to test the proper operation of several elements of the monitoring device (pumps, detection sensors, etc.).

It is understood that the example described above is for illustrative purposes only, and that any type of sensor among the detection sensors 20 could be implemented, alone or in combination with similar sensors or of different natures, to measure different physical parameters relative to the volume of water discharged into the first container.

### Lifting of Doubt Video

In one embodiment, a video acquisition command is automatically generated following the reception of the first signal S₁ by the calculator K₁. “Video acquisition command” is taken to mean both an image acquisition command and a video sequence acquisition command. The video acquisition command is for example transmitted spontaneously by means of the communication interface INT₁ to an optical sensor or a camera 7 of the monitoring system, following reception of the signal S₁. One advantage is to be able to carry out a lifting of doubt video within the room 100 to ensure the presence of a leak or flooding in said room 100.

In one embodiment, the video acquisition command is automatically generated by the calculator K₁ following the reception of the consumption information C_{elec} by said calculator K₁. The consumption information C_{elec} comprises for example information read by the electrical meter 6 on the consumption of one or more items of equipment of the drainage system 11. For example, the video acquisition command is transmitted spontaneously by means of the communication interface INT₁ to an optical sensor or a camera 7 of the monitoring system. One advantage is to be able to carry out a lifting of doubt video of the malfunction of one or more items of equipment of the drainage system 11. For example, if the consumption information C_{elec} comprises an electrical consumption information of the drainage system 11 below a predefined threshold, the video acquisition command makes it possible to carry out a lifting of doubt video within the room 100. Advantageously, if the presence of the volume of water 3 is proven within the room 100, it is possible to deduce from this a malfunction of the drainage system 11.

In one embodiment, the generation of a command to activate an equipment of the hydraulic system 10 automatically causes the generation of a video acquisition command by the calculator K₁. In an illustrative example, the generation of an opening or closing command of a valve such as a solenoid valve or a control valve automatically causes the generation of a video acquisition command by the calculator K₁. The acquired images and/or video sequences are for example transmitted spontaneously and automatically to a remote equipment such as the remote equipment E₁ by means of the communication interface INT₁. One advantage is to be able to check the operation of one or more items of hydraulic equipment in real time. Another advantage is to be able to ensure in real time the proper operation of other items of equipment of the device such as the equipment of the drainage system 11.

### Memory

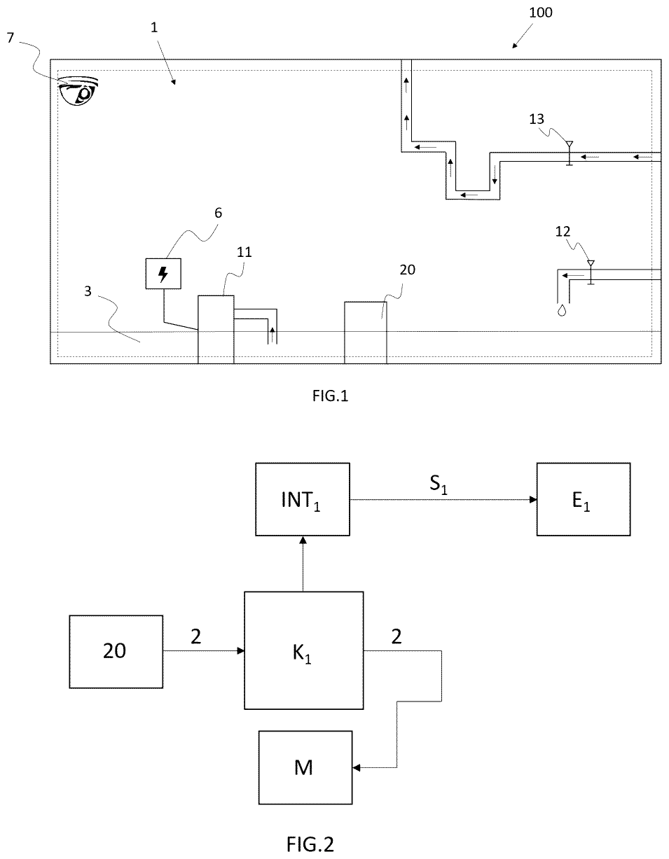

In one embodiment, with reference to FIG. 2, the monitoring device comprises a memory M. The memory M is implemented to record data within the monitoring system 1.

According to one embodiment, the memory M of the monitoring device 1 comprises the memory of the calculator K₁.

According to one embodiment, the data from the different detection sensors 20 of the device are recorded within the memory M. Thus, the memory M may comprise data of different physical parameters measured by said detection sensors 20 such as temperature, pressure, speed, flow rate, volume or humidity data.

In one embodiment, the data acquired by an optical sensor or by a camera 7 are recorded within the memory M. The recorded data are for example images and/or video sequences acquired by at least one optical sensor or by at least one camera 7.

According to one embodiment, the data recorded within the memory M comprises data acquired by different detection sensors 20 and a timestamp of such data. “Timestamp” of the data is taken to mean a timestamp of the acquisition of said data by a sensor and/or a timestamp of the recording of said data within the memory M.

According to further exemplary embodiments, the data of sensors not forming part of the detection sensors 20 are recorded within the memory M. These may be for example temperature or pressure measurements read by temperature or pressure probes of the monitoring device 1.

In one embodiment, data comprised in the signals S₁, S₂, S₃, S₄ are recorded within the memory M. The data are obtained for example by the decoding of said signals S₁, S₂, S₃, S₄ by the calculator K₁. The data obtained are for example the raw data contained in the signals S₁, S₂, S₃, S₄ or data from the processing of said raw data by the calculator K₁. The data stored in the memory M may also comprise a timestamp of the data contained in the signals S₁, S₂, S₃, S₄. In one example, the timestamp of the data comprises a timestamp of the acquisition of the raw data by the different sensors, a timestamp of the transmission of said raw data or even a timestamp of the reception of said signals S₁, S₂, S₃, S₄ by the communication interface INT₁ of the monitoring device.

Thus, the data contained in the memory M of the monitoring device may comprise both data acquired by the different sensors and the different probes of the device and data transmitted by equipment of a third party system, for example transmitted by means of the fourth signal S₄.

In one embodiment, the data stored in the memory M is periodically transmitted to a third-party equipment. The data stored in memory M are for example transmitted at regular intervals to an equipment in a data network such as a data server, or to the remote equipment E₁. One advantage is to free up memory space at regular intervals to prevent saturation of said memory M.

In one embodiment, the data recorded in the memory M are transmitted spontaneously and automatically to a third party equipment such as the equipment E₁, for example by means of the communication interface INT₁. In another example, the data are transmitted spontaneously and automatically to a data server as soon as they are recorded in the memory M.

### Monitoring System

According to another aspect, the invention relates to a system for monitoring a plurality of rooms 100.

In one embodiment, each room 100 of the system comprises a monitoring device 1 according to any one of the embodiments according to the first aspect of the invention.

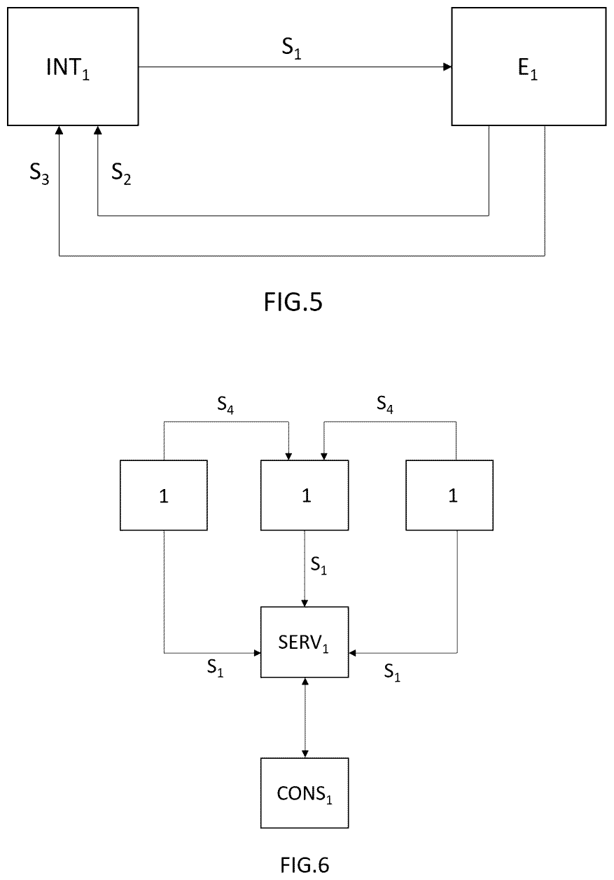

In one embodiment, with reference to FIG. 6, the system comprises a data server SERV₁. The data server SERV₁ is for example implemented to record the data from the monitoring devices 1 of each room 100. For example, the data are transmitted to the server SERV₁ via the communication interfaces of each monitoring device 1 of each room 100. The data are for example transmitted in the form of the first signal S₁ for each room, generated by the calculator of each monitoring device 1 as a function of the information read by the different sensors of each of said rooms 100. One advantage is to be able to centralize the information acquired by different sensors of different rooms 100, within the server SERV₁. Another advantage is to be able to take into account parameters measured within other rooms to identify the causes of the presence of water in a room 100. Another advantage is to be able to implement a prevention system within each room 100. For example, if several rooms have been flooded due to the malfunction of similar equipment, preventive maintenance may be implemented in the rooms that have not yet been flooded to control such equipment and thus prevent a risk of leakage or possible flooding.

In one embodiment, the server SERV₁ is configured to receive data from a remote equipment outside of the monitoring device. The data are for example meteorological data transmitted from a weather station, data from a data server, for example comprising information on flood risks, or data from probes or sensors positioned outside the premises 100. This information is for example transmitted in the form of “.csv” files. According to one embodiment, the data are transmitted to the server SERV₁ using a Rest API provided by the server SERV₁. The data may also be transmitted to the remote server SERV₁ by means of a Rest API provided by the remote equipment originating this data or by any other equipment having said data. The data are for example processed by the server SERV₁ to deduce therefrom context information. The context information corresponds for example to information on weather conditions. One advantage is to be able to take into account parameters external to the system to determine the causes of the presence of the volume of water 3 in a room 100. Another advantage is to issue a forecast alert when conditions (flood, bad weather, etc.) favoring flooding are met.

According to one embodiment, the server SERV₁ is configured to emit notifications in the form of SMS alerts or even email alerts.

In one embodiment, the remote equipment E₁ comprises the data server SERV₁.

In one embodiment, the system comprises a hardware resource defining an operating console CONS₁. The operating console CONS₁ comprises for example a display. The display is for example implemented to display a visual representation of a plurality of rooms 100. This is possible for example when the cameras 7 or the optical sensors are connected in real time with said operating console CONS₁. One advantage is to be able to monitor the status of the various rooms in real time, for example to check for the presence of leaks or flooding in said rooms.

In one embodiment, the remote equipment E₁ comprises the operating console CONS₁.

In one embodiment, the operating console CONS₁ is configured to generate at least one status indicator of a plurality of monitoring devices 1. The status indicator comprises for example a visual marker characteristic of the presence of the volume of water 3 in said rooms 100. The visual marker comprises for example a color code to indicate the status of each room 100. “Status” of each room is taken to mean a flooding status of each room 100. A visual indicator corresponds for example to a flooding in progress, a critical state or an absence of flooding in a room 100. The status indicator may also comprise a datum characteristic of the presence or not of the volume of water 3 in each of the rooms 100. The characteristic datum corresponds for example to information measured by the detection sensors 20 of each of the monitoring devices 1, data processed by the calculators K₁ of each of the monitoring devices 1, or data transmitted or received by the communication interfaces INT₁ of each monitoring device 1. According to one example, the status indicator comprises context information, said context information comprising information on weather conditions or flood risks.

In one embodiment, the monitoring system comprises a memory for recording the history of events associated with at least one room 100 among the plurality of rooms of the system. The event history comprises for example the data read by the detection sensors 20 of each room 100, the consumption information C_{elec} read by each electrical meter 6 of each room 100, the water consumption information read by each water meter Cₑ of each room 100, the images acquired by the cameras 7 or the optical sensors of each room 100, the detection of a leak or flooding in each room 100 or the detection of a malfunction of an apparatus of each monitoring device 1, for example of a drainage system 11.

According to another aspect, the invention relates to a method for monitoring a room 100, the method comprising the following steps:
A step of measuring at least one physical parameter 2 by means of a detection sensor 20;
A step of deducing the presence of a volume of water 3 in said room 100 from the measured physical parameter;
A step of emitting a first signal S₁ when the volume of water 3 exceeds a predefined threshold;
A step of receiving a second signal S₂ in response to the emission of said first signal S₁.

It is understood that the second signal S₂ is received “in response to the emission of the first signal S₁” by the fact that the second signal S₂ is transmitted after reception of the first signal S₁ by the remote equipment E₁ to which said first signal S₁ has been emitted. The transmission of the second signal S₂ may be automatic and spontaneous after reception of the first signal S₁ by the remote equipment E₁. According to another example, the emission of the second signal S₂ is derived from an emission command implemented by means of a request from a user.

1. A monitoring device for monitoring a room, said monitoring device comprising:
a plurality of detection sensors configured to measure a plurality of physical parameters, wherein values of the measured plurality of physical parameters are characteristic of a presence of a volume of water in the room, each of said detection sensors being configured to measure a different physical parameter;
a calculator configured to:
calculate a characteristic value of the volume of water from the plurality of physical parameters measured by the detection sensors;
compare said characteristic value of said volume of water with at least one threshold value;
generate a reliability signal from the measured physical parameters, said reliability signal allowing reliable detection of the presence of said volume of water in said room;
a communication interface to emit said reliability signal to at least one remote equipment when the characteristic value of the volume of water is greater than or equal to said threshold value.

2. The monitoring device according to claim 1, wherein at least one sensor for detecting a physical parameter is an ultrasonic sensor arranged to emit signals at regular time intervals towards a floor of said room, each emitted signal being reflected towards said ultrasonic sensor, said reliability signal being calculated as a function of a distance traveled or a travel time of said emitted and reflected signals.

3. The monitoring device according to claim 2, wherein the ultrasonic sensor is coupled to a temperature probe allowing a temperature of the room to be measured, said measured temperature being taken into account in the processing of the emitted and reflected signal to calculate the reliability signal.

4. The monitoring device according to claim 1, wherein at least one sensor for detecting a physical parameter is a float level sensor, said float being arranged in said room and said float actuating an electrical, mechanical or magnetic contact to generate the production of an electrical current measured by said sensor.

5. The monitoring device according to claim 1, wherein at least one sensor for detecting a physical parameter is a conductivity measurement detector, said detection sensor comprising two contacts of an open electrical circuit and configured to detect an electrical current generated by the closing of the electrical circuit, said closing of the circuit being caused by the presence of a conductive volume of water.

6. The monitoring device according to claim 1, wherein at least one detection sensor is a water meter configured to measure a physical parameter relating to a fluid passing through equipment of a hydraulic system installed for at least a part in said room or in its proximity, counting information relative to said fluid passing through being sent to said remote equipment by means of the communication interface.

7. The monitoring device according to claim 1, wherein at least one sensor for detecting a physical parameter is a pressure sensor, said sensor comprising at least one element sensitive to the pressure exerted by a fluid on said pressure sensor.

8. The monitoring device according to claim 1, wherein at least one sensor for detecting a physical parameter is an optical sensor configured to acquire images of at least one part of the room, said monitoring device comprising a software component to automatically process the acquired images and deduce an element characteristic of the presence of the volume of water in said room.

9. The monitoring device according to claim 1, wherein at least one sensor for detecting a physical parameter is a humidity sensor measuring a volume of water evaporated within said room.

10. The monitoring device according to claim 1, wherein the reliability signal is generated by the calculator from at least two separate measurements performed by at least two separate detection sensors among:
an ultrasonic sensor arranged to emit signals at regular time intervals towards a floor of said room, each emitted signal being reflected to said ultrasonic sensor;
a humidity sensor measuring a volume of water evaporated within said room;
an optical sensor configured to acquire images of at least one part of the room;
a float level detector, said float being arranged in said room and said float actuating an electrical, mechanical or magnetic contact to generate the production of an electrical current measured by said sensor;
a conductivity measurement sensor comprising two contacts of an open electrical circuit and configured to detect an electrical current generated by the closing of the electrical circuit, said closing of the circuit being caused by the presence of a conductive volume of water;
a pressure sensor comprising at least one element sensitive to the pressure exerted by a fluid on said pressure sensor,
a water meter configured to measure a physical parameter relating to a fluid passing through equipment of a hydraulic system installed for at least a part in said room.

11. The monitoring device according to claim 1, comprising the remote equipment configured to generate, in response to a reception and processing of said reliability signal, a command of at least one hydraulic equipment.

12. The monitoring device according to claim 11, wherein at least one hydraulic equipment is a solenoid valve.

13. The monitoring device according to claim 1, comprising a main container and a secondary container arranged in the room, said secondary container comprising means for allowing a volume of water discharged into the main container to pass into said secondary container when a pressure is applied by said discharged volume of water on said means, at least one of the sensors for detecting a physical parameter being placed in one of said containers to measure a physical parameter associated with said discharged volume of water, said detection sensor being configured to transmit in real time to the calculator said physical parameter and the calculator being configured to generate a command to activate at least one hydraulic equipment in order to vary, in one of said containers, the height of said discharged volume of water.

14. The monitoring device according to claim 1, comprising an electrical meter for measuring electrical consumption values of a drainage system, the calculator being configured to compare said measured electrical consumption values with threshold values and to generate an alert being emitted to the remote equipment by means of the communication interface when said electrical meter has read an electrical consumption lower than a predefined threshold, either:
during a first predefined time interval;
during a second predefined time interval after the emission of the reliability signal;
during a third predefined time interval after the emission of a command to actuate a first hydraulic equipment of the hydraulic system;
during a predefined cumulative time interval, said predefined cumulative time interval comprising a sum of several cumulative time intervals over a predefined period.

15. The monitoring device according to claim 1, wherein the communication interface is configured to receive a second signal from a third party electronic equipment in response to the reliability signal emitted to the first remote equipment, said second signal comprising a command to actuate at least one lift pump to lower the volume of water in the room.

16. The monitoring device according to claim 1, wherein the communication interface is configured to receive a third signal in response to the emission of the reliability signal, said third signal comprising a command to acquire at least one image or at least one video sequence by at least one camera, said at least one image or video sequence being automatically transmitted to the remote equipment.

17. The monitoring device according to claim 1, wherein the communication interface is configured to receive a fourth signal.

18. The monitoring device according to claim 17, wherein the communication interface is configured to receive the fourth signal comprising data transmitted by a monitoring device of at least one other room.

19. The monitoring device according to claim 17, wherein the communication interface is configured to receive the fourth signal comprising data transmitted by at least one equipment remote from the room.

20. The monitoring device according to claim 19, wherein the communication interface is configured to receive the fourth signal comprising meteorological data, data from a remote server, data from sensors positioned outside the room, or a combination of these data.

21. A system for monitoring a plurality of rooms comprising:
a plurality of monitoring devices according to claim 1;
a data server to record the first signals emitted by the monitoring devices;
a hardware resource defining an operating console comprising a display to generate a visual representation of a plurality of monitoring devices and generate a status indicator of each room associated with each monitoring device, said status indicator comprising a datum characteristic of the presence or not of a volume of water associated with each monitoring device, and
a memory to record the history of events associated with said at least one room.

22. A method for monitoring a room comprising:
measuring a plurality of different physical parameters by means of a plurality of detection sensors, each detection sensor measuring a different physical parameter;
calculating, by a calculator, a characteristic value of a volume of water present in the room from the physical parameters measured;
comparing, by the calculator, of the characteristic value of the volume of water with at least one threshold value;
generating, by the calculator, a reliability signal from the measured physical parameters, said reliability signal allowing reliable detection of the presence of said volume of water in said room,
emitting, by a communication interface and to at least one remote equipment, said reliability signal when the characteristic value of the volume of water is greater than or equal to said threshold value.
